(19) United States
(12) Patent Application Publication
(10) Pub. No.: US 2007/0170404 A1
(43) Pub. Date: Jul. 26, 2007

(54) Fire retardant with mold inhibitor and insecticide

(75) Inventor: William Kish, Wadsworth, OH (US)

Correspondence Address: CHRISTOPHER JOHN RUDY, 209 HURON AVENUE, SUITE 8, PORT HURON, MI, 48060, US

(73) Assignee: No-Burn Investments, LLC, Wadsworth, OH (US)

(21) Appl. No.: 11/654,431

(22) Filed: Jan. 17, 2007

Related U.S. Application Data
(60) Provisional application No. 60/761,006, filed on Jan. 20, 2006.

(51) Int. Cl. C09K 21/00

(52) U.S. Cl. 252/601

(57) ABSTRACT

Composition includes a fire retardant, a mold inhibitor, and an insecticide. The fire retardant can be at least initially in a foundational form of an aqueous liquid of light viscosity and strength, which is capable of being sprayed on.

This claims benefits under 35 USC 119(e) of application No. U.S.60/761,006 filed on Jan. 20, 2006 A.D., the specification of which is incorporated herein by reference.

### FIELD AND PURVIEW OF THE INVENTION

The present invention concerns a fire retardant composition having a mold inhibitor and an insecticide, and methods for making and using it, as well as the composition in combination with a substrate.

### BACKGROUND TO THE INVENTION

Various fire retardants are known. Among these are those having a mold inhibitor, a number of which are commercially available from No-Burn, Inc., Wadsworth, Ohio. Compare, patent No. U.S. Pat. No. 6,982,049 B1; U.S. patent application Pub. Nos. 2005/0138888 and 2005/0022466; U.S. utility patent application Ser. No. 11/320,207; and U.S. provisional patent application Nos. 60/670,121 and 60/656,148—the specifications of all of these incorporated herein by reference.

Insect damage to building structures, including homes, notably, for example, from termites, especially in warmer climates, is also a problem of concern.

It would be desirable to address problems in and improve the art.

### A FULL DISCLOSURE OF THE INVENTION

In address of the foregoing problems, in general, the present invention provides a fire retardant composition having a mold inhibitor and an insecticide. It can be made by contacting fire retardant, mold inhibitor, and insecticide ingredients under conditions sufficient to form the composition, and it can be used by applying it to a substrate in an amount sufficient to kill, control and/or repel a target invertebrate. It thus can be found in combination with the substrate itself or as a residue whereof.

The invention is useful in preservation and enhancement of buildings and fabrics.

Significantly, by the invention, the art is improved in kind. Not only can fire retardant and mold inhibition properties be provided a building structure and fabrics but also can be insect control, and this, notably, in one convenient composition. Fear and destruction of fire, and damage or harassment otherwise caused by mold such as toxic black mold and insects such as termites, carpenter ants, bees, and so forth can be put to rest confidently.

Numerous further advantages attend the invention.

The invention can be further understood by the detail set forth below. This is, as with the foregoing, to be read in an illustrative and not necessarily limiting sense.

Hereby, a composition otherwise including a fire retardant and a mold inhibitor is also provided with an insecticide. Any suitable fire retardant, mold inhibitor, and insecticide may be employed, in any suitable amount. Preferably, the fire retardant and mold inhibitor is selected from those covered by the aforementioned patent No. U.S. Pat. No. 6,982,049 B1; application Pub. Nos. 2005/0138888 and 2005/0022466; application Ser. No. 11/320,207; and application Nos. 60/670,121 and 60/656,148, with the term, “fire retardant,” being a composition that, when applied to a flammable material, provides thermal protection for the material, which, in general, may be done by reducing or perhaps even eliminating the tendency of the material to burn and/or by reducing the rate of flame spread along the surface of the material, and preferably, in use in the fire retardant composition, for example, on a solid material such as wood substrate, reduces surface burning characteristics significantly, say, at least about 10%, at least about 25%, or at least about 50%, when compared to corresponding but untreated material, as tested by an appropriate test, for example, the ASTM E84 Steiner Tunnel Test; and the term, “mold inhibitor,” being an agent that can kill, control, or prevent growth of mold, mildew, or fungus, and so forth and the like flora, especially when formulated with a foundational composition, with insecticide, which, preferably, however, in use in the present composition, for example, on a solid material as the substrate, reduces growth of the flora of interest significantly, say, at least about 60%, at least about 85%, or at least about 99% or even at least about 99.9%, if it does not kill it outright, for a significant time, say, at least about thirty days, at least about six months, or at least about 360 days or a year, if not, in effect, indefinitely, as tested by appropriate test methodology, for example, by ASTM D5590-94, Determination of Resistance of a Coating Material to Fungal Growth. Beneficially, control of toxic black mold (Stachybotrys chartarum)is provided hereby. Accordingly, although NO-BURN® Wood Gard Mih fire retardant with mold inhibitor and NO-BURN® Plus Mih intumescent latex paint with mold inhibitor may be employed, NO-BURN® Fire Gard fire retardant spray (Fabric Fire Gard fire retardant spray) may be provided with a mold inhibitor such as a quaternary organic ammonium halide, and Fabric Fire Gard fire retardant spray is an example of a spray-on liquid of light viscosity and strength, which is an aqueous proprietary product with a formulation that can vary but that can include, in general, such ingredients, with percentages (%) by weight, as follows:

| | |
|---|---|
| Water | 70~90% to include 76~82% |
| Phosphorus containing acid, e.g., as | 5~15% to include 10~12% |
| polyphosphoric acid (115%) | |
| Ammonium base, e.g., as hydroxide | 5~15% to include 8~10% |
| (29% aqueous solution) | |
| Wetting and/or other agent such as | 0.05~0.2% to include 0.09~0.13% |
| coco amidopropyl betaine | |
| (30% aqueous solution) | |
| Preservative, e.g., potassium | 0.01~0.1% to include 0.04~0.06%. |
| salicylate | |

For example, an alkyldimethylbenzylammonium chloride and/or didecyldimethylammonium chloride may be employed, notably the former. Thus, fire retardant properties and control of mold such as the toxic black mold (Stachybotrys chartarum) are provided.

Herein, the term, “insecticide,” is an agent that can kill, control and/or repel a target invertebrate. The target invertebrate can be an insect per se, for example, a termite, a carpenter, sweet or grease eating ant, a bee, hornet or wasp, a roach, a fly, a mosquito, a cricket, an earwig, a silverfish, a tick, a flea, a beetle, and so forth; another arthropod such as a spider, a centipede, and so forth; and/or a worm or even a snail or slug, and so forth. Target invertebrates considered building pests, which could include the termites, ants, bees, hornets and wasps, roaches, crickets, earwigs, silverfish, fleas, beetles, and spiders, especially termites, desirably are killed, controlled and/or repelled hereby.

As indicated above, any suitable insecticide can be employed in the practice of the present invention, alone or in combination with another insecticide. Preferably, the insecticide is soluble or otherwise able to be carried with the remaining ingredients of the invention such as by dispersion, emulsion, and so forth, and preferably does not hinder any solubility or otherwise any capacity for being carried likewise of other ingredients of the composition of the invention, for example, the mold inhibitor. Preferably, too, the insecticide does not alter, at least significantly, other desirable physical characteristics of the composition that would otherwise exist without it such as, for example, pH. Preferably also, the insecticide is stable in the composition before, i.e., “in the can,” and after application to the substrate, so as to provide for contact with the target invertebrate. Be that as it may, the insecticide may be or include inorganic, organic, natural and/or synthetic components, thus perhaps being or including Arsenic, Lead, Mercury, Thallium, or a compound of such, Phosphorus, an organophosphate, Sulfur, an organothio compound, a chlorinated organic compound, a pyrethroid, carbamide, carbimide, cyclopropanecarboxylate, a pyrethrin, and/or a piperonyl ether; examples may include, malathion, parathion, diazinon (0,0-diethyl-0,2-isopropyl-6-methyl(pyrinodine-4-yl)phosphorthioate), permethrin ((3-phenoxyphenyl)methyl(±)cis-trans-3-(2,2-dichloroethenyl)-2,2-dimethylcyclopropanecarboxylate) or CAS No. 52645-53-1), resmethrin, d-trans-allethrin, tetramethrin ((1-cyclohexene-1,2-dicarboximide)methyl-2,2-dimethyl-3-(2-methylpropenyl)cyclopropanecarboxylate), sumithrin (3-phenoxybenzyl-(1RS,3RS;1RS,3SR)-2,2-dimethyl-3-(2-methylprop-1-enyl)cyclopropanecarboxylate), piperonyl butoxide and butylcarbityl(6-propylpiperonyl) ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate, others, and so forth and the like.

As also indicated above, any suitable amount of the insecticide may be employed. The amount may be any that is sufficient to kill, control and/or repel a target invertebrate when the composition is applied to, and preferably dried on or in, a substrate. The insecticide may be, independently at each occurrence, say, from 0.01% to 50% by weight of total composition, say, from 0.1% or 1% to 3%, 5% or 10% by weight of the total composition. Such values may be considered to be approximate or precise.

Other ingredient(s) may be present. For instance, a colorant and/or a stain protectant or soil release agent may be employed, the latter, for example, especially for fabrics.

The composition can be made by any suitable method. Ingredients may be in a form of a gas, liquid or solid. For instance, a liquid mixture may be contacted with a gaseous, liquid or powdered insecticide. Agitation as by stirring, sonic mixing, and so forth may render the composition more homogeneous or otherwise aid in suspending ingredient(s).

The composition can be applied to the substrate by any suitable method. Thus, for instance, after stirring, brushing, spraying, dipping and so forth may be employed. Preferably, the composition of the invention dries after application to the substrate.

As the substrate, any suitable substance may be employed. Preferably, however, the substrate is solid and would otherwise be flammable were it not for the application of the present composition. Substrates can include those of wood, fabric, paper, and so forth.

### CONCLUSION TO THE INVENTION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

What is claimed is:

1. A composition of matter comprising a fire retardant, a mold inhibitor, and an insecticide, wherein the fire retardant is at least initially in a foundational form of an aqueous liquid of light viscosity and strength, which is capable of being sprayed on; the mold inhibitor is present in an amount sufficient to kill, control and/or repel a target mold, mildew, or fungus, and so forth and the like flora when the composition is applied to, and optionally dried on or in, a substrate; and the insecticide is present in an amount sufficient to kill, control and/or repel a target invertebrate when the composition is applied to, and optionally dried on or in, the substrate.

2. The composition of claim 1, wherein the foundational fire retardant is a liquid having ingredients with percentages (%) by weight, as follows:

| | |
|---|---|
| Water | 70~90% |
| Phosphorus containing acid | 5~15% |
| Ammonium base | 5~15% |
| Wetting and/or other | 0.05~0.2% |
| Preservative | 0.01~0.1%. |

3. The composition of claim 1, wherein the foundational fire retardant is a liquid having ingredients with percentages (%) by weight, as follows:

| | |
|---|---|
| Water | 76~82% |
| Polyphosphoric acid (115%) | 10~42% |
| Ammonium hydroxide (29% aqueous solution) | 8~10% |
| Coco amidopropyl betaine (30% aqueous solution) | 0.09~0.13% |
| Potassium salicylate | 0.04~0.06%. |

4. The composition of claim 3, wherein the mold inhibitor includes an alkyldimethylbenzylammonium chloride and/or didecyldimethylammonium chloride; and the insecticide includes an organic compound.

5. The composition of claim 1, wherein the target mold, mildew, or fungus, and so forth and the like flora includes Stachybotrys chartarum; and the target invertebrate includes an arthropod.

6. The composition of claim 1, wherein the mold inhibitor includes a quaternary organic ammonium halide; and the insecticide includes an organic compound.

7. The composition of claim 10, wherein the mold inhibitor includes a quaternary ammonium alkyl halide; and the insecticide includes an organothio compound, a chlorinated organic compound, a pyrethroid, a carbamide, a carbimide, a cyclopropanecarboxylate, a pyrethrin, and/or a piperonyl ether.

8. The composition of claim 1, wherein the mold inhibitor includes a quaternary alkyl ammonium halide, which includes at least one short chain alkyl group and at least one medium chain alkyl group, wherein the short chain alkyl group is, separately at each occurrence, a one- to an about five-carbon group, and the medium chain alkyl group is, separately at each occurrence, an about six- to an about thirty-carbon group; and the insecticide includes a substance selected from the group consisting of malathion, parathion, diazinon (0,0-diethyl-0,2-isopropyl-6-methyl(pyrinodine-4-yl)phosphorthioate), permethrin ((3-phenoxyphenyl)methyl(±)cis-trans-3-(2,2-dichloroethenyl)-2,2-dimethylcyclopropanecarboxylate) or CAS No. 52645-53-1), resmethrin, d-trans-allethrin, tetramethrin ((1-cyclohexene-1,2-dicarboximide)methyl-2,2-dimethyl-3-(2-methylpropenyl)cyclopropanecarboxylate), sumithrin (3-phenoxybenzyl-(1RS,3RS;1RS,3SR)-2,2-dimethyl-3-(2-methylprop-1-enyl)cyclopropanecarboxylate), piperonyl butoxide and butylcarbityl(6-propylpiperonyl) ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate and a combination thereof.

9. The composition of claim 8, wherein the mold inhibitor is present in an amount about from 0.1% to 10% by weight of the total composition, and the insecticide is present in an amount about from 0.1% to 10% by weight of the total composition.

10. The composition of claim 1, which includes a stain protectant or soil release agent for fabrics.

11. In combination, the composition of claim 1, and the substrate on or in which the composition resides.

12. The combination of claim 11, wherein the composition is dried.
